(19) United States
(12) Patent Application Publication
(10) Pub. No.: US 2007/0275174 A1
(43) Pub. Date: Nov. 29, 2007

(54) Fishing fly and fly fishing line with fluorocarbon coating

(76) Inventors: Eric L. Hanson, San Diego, CA (US); Eric L. Bruner, San Diego, CA (US)

Correspondence Address: William J. Uhl, 4110 Devonwood Court, Murrysville, PA, 15668, US

(21) Appl. No.: 11/805,439

(22) Filed: May 23, 2007

Related U.S. Application Data
(60) Provisional application No. 60/808,037, filed on May 24, 2006.

(51) Int. Cl. A01K 85/08

(52) U.S. Cl. 427/421.1; 427/455; 43/4.5; 43/42.25

(57) ABSTRACT

A method of coating a fishing lure such as a fly and/or a fly fishing line with a fluorocarbon dissolved or dispersed in a liquid diluent is disclosed.

### CROSS REFERENCE TO RELATED APPLICATION

The present application claims priority from U.S. Provisional Patent Application Ser. No. 60/808,037, filed May 24, 2006.

### FIELD OF THE INVENTION

The present invention relates to treating a fishing lure such as a fly and a fishing line to make the fly and line hydrophobic such that they float on water.

### BACKGROUND OF THE INVENTION

So-called dry fishing flies are fishing lures made to imitate insects that float on the water's surface. A dry fly is usually made from feathers and is attached to a fishing line typically through a leader. After a few casts and contact with the water, the feathers become wet, and as more water is taken up, the fly sinks in the water making it an ineffective lure. The fly must then be completely dried before it becomes useful again.

To overcome the wetting problems, it is known to coat the fly with a hydrophobic material such as a silicone oil or a solid wax. Both of these materials are difficult to apply in the field. The silicone oils are greasy, somewhat viscous and do not completely cover the feathers. Also, the feathers may mat deforming the fly and making it unattractive to fish. The solid waxes are even more difficult to apply and must first be heated to liquefy the wax before treating the fly. Obviously, this is very difficult to do in the field. Also, the fly should be dry before application. Finally, the degree of improvement with application of these materials is marginal compared to the untreated fly. The materials wash off after about five or six casts.

It is also known to treat fishing flies with gaseous hydrophobic materials including gaseous fluorocarbons. However, gaseous materials cannot be field applied.

### SUMMARY OF THE INVENTION

A method of coating a fishing fly and/or a fly fishing line comprising contacting the fishing fly and/or the fly fishing line with a film-forming fluorocarbon material dissolved or dispersed in a liquid diluent. The invention also provides for a fishing fly and/or a fly fishing line, that may be connected with one another and that are coated with a solution or dispersion of the fluorocarbon material.

### DETAILED DESCRIPTION OF THE INVENTION

The fishing fly is typically made from various filamentous materials such as hackle feathers from birds such as chickens as well as animal hair or synthetic fibers. The fly comprises a plurality of filaments arranged to look like an insect.

The fly fishing line typically comprises a core and an outer layer or body surrounding the core. The core is often made of braided filaments such as nylon, polypropylene, polyethylene or silk. The outer layer or body is typically a plastisol such as polyvinyl chloride with a lubricant that is extruded onto the core.

The fluorocarbon which is applied to the fishing fly and/or the fly fishing line is a fluorocarbon that is a film former which will coat and conform to the filaments associated with the fly and/or the fishing line. Examples of suitable fluorocarbons are oligomeric or polymeric fluorocarbons, particularly oligomeric or polymeric perfluoromaterials (“perfluoropolymers”). By perfluoro is meant a substituent having one or more CₙF₂ₙ₊₁ groups and preferably a terminal —CF₃ group. Examples of suitable perfluoropolymers are perfluoroalcohols such as CₙF₂ₙ₊₁—(CF₂CF₂)_{b}—CH₂—CH₂—OH (where b is 2 to 10 and n is 1 to 6), esters of perfluoroalcohols including monoesters such as stearic acid ester, diesters such as the adipate ester and triesters such as the citrate ester. A class of particularly preferred perfluoropolymers are perfluorophosphorus acids such as perfluoroalkylene ether phosphorus acid such as those of the structure:

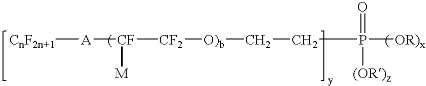

where x is 0 to 1; y is 1; z is 1 to 2; and x+y+z is 3; R is a radical having a total of 1 to 30 carbon atoms; R′ is selected from H, a metal or lower alkyl having 1 to 4 carbon atoms; A is oxygen radical or a chemical bond; n is 1 to 6; M is F or CₙF₂ₙ₊₁; and those of the structure:

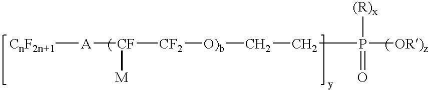

where x is 0 to 1; y is 1 to 2; z is 1; and x+y+z is 3; R is a radical having a total of 1 to 30 carbon atoms; R′ is selected from H, a metal or lower alkyl having 1 to 4 carbon atoms; A is oxygen radical or a chemical bond; n is 1 to 6; M is F or CₙF₂ₙ₊₁.

For application to the fishing fly or fishing line, the perfluoropolymer is dissolved or dispersed in a liquid diluent. The concentration of the perfluoropolymer is somewhat critical and should be greater than 0.01 micromolar and less than 500 micromolar. Amounts less than 0.01 micromolar or less do not provide the desired hydrophobicity to the fly or coating line, whereas amounts of 500 micromolar or higher provide too heavy a coating causing the fly and line to sink beneath the water's surface. Examples of suitable diluents are hydrocarbons such as pentane, hexane and toluene; ketones such as methyl ethyl ketone; alcohols such as methanol and ethanol; water; ethers such as tetrahydrofuran and particularly fluorinated solvents such as nonafluorobutylmethyl ether, including mixtures thereof. The fluorinated solvents are different from the film-forming fluorocarbons in that the fluorinated solvents are not film formers. Preferably, the vapor pressure of the solvent is high, permitting rapid evaporation at room temperature (20-25° C.). If the fluorocarbon is soluble in the diluent, it can be dissolved easily upon adding the fluorocarbon to the diluent. If on the other hand it is not soluble in the diluent, it can be dispersed in the diluent with the aid of a dispersant or surfactant. Examples of suitable dispersants or surfactants are nonionic surfactants such as nonyl phenol.

The fluorocarbon solution or dispersion can easily be applied to the fishing fly or line by any combination of methods. For application to the fly, the solution or dispersion of the fluorocarbon can be sprayed onto the fly or can be flowed over the surface of the fly, for example, by using an eyedropper. Also, the fly can be dipped into the solution or the dispersion of the fluorocarbon and the excess shaken off. Application to the line can easily be accomplished by spraying, dipping or moistening a cloth with the fluorocarbon solution or dispersion and passing the cloth over the fishing line. All of these methods of application can be done easily in the field or can of course be done beforehand in a factory-applied setting. After application of the fluorocarbon, the diluent is permitted to evaporate, preferably at ambient temperature, or in a factory application, by the application of heat.

The resultant coating is thin, having a thickness of about 0.1 to 5 microns. The coating is conformal, encapsulating the individual feathers of the fly thereby preserving the details of the fly in that the filaments of the fly are not clustered together. The coatings are continuous and substantially pinhole free and are considerably hydrophobic. The coated fly wets only on its surface and simple back casting will shed the water from the fly and the line presenting essentially dry hydrophobic fly and line that floats on the water in subsequent casting.

Optionally, a primer coat of an organo metallic compound can be applied to the fly and/or fishing line prior to the fluorocarbon film former in order to enhance the bonding strength of the fluorocarbon to the lure and/or the fishing line.

Examples of such film formers are metal alkoxides such as those of the structure:

M(OR)₄

where M is selected from a metal or metalloid selected from Group III of the Periodic Table or a transition metal selected from Group IVB, VB and VIB of the Periodic Table. Preferred metals are transition metals selected from Group VIB such as titanium and zirconium; and R is C₁₋₁₈ alkyl. The metal alkoxide primers are particularly useful with the perfluorophosphorus acids.

The invention is set forth in the following claims.

What is claimed is:

1. A method of coating a fishing lure and/or a fishing line comprising contacting the fishing lure and/or the fishing line directly or through an intermediate primer coating with a film-forming fluorocarbon dissolved or dispersed in a liquid diluent.

2. The method of claim 1 in which the fishing lure is in the form of a fly.

3. The method of claim 2 in which the solution or dispersion is applied by spraying onto the fishing fly.

4. The method of claim 2 in which the solution or dispersion is flow coated over the fishing fly.

5. The method of claim 2 in which the fishing fly is dipped in a solution or dispersion of the fluorocarbon.

6. The method of claim 1 in which the liquid diluent is selected from hydrocarbons, ketones, ethers, alcohols, fluorinated solvents, water and mixtures thereof.

7. The method of claim 1 in which the fluorocarbon material is present in the liquid diluent in amounts greater than 0.01 micromolar to less than 500 micromolar.

8. The method of claim 1 in which the fluorocarbon is a perfluoro oligomer or polymer.

9. The method of claim 8 in which the perfluoro oligomer or polymer is a perfluorophosphorus material.

10. The method of claim 8 in which the perfluoro polymer or oligomer is a perfluorophosphorus acid.

11. The method of claim 10 in which the perfluorophosphorus acid is a phosphonic acid.

12. The method of claim 10 in which the perfluorophosphorus acid is a perfluoroalkylene ether phosphorus acid.

13. The method of claim 12 in which the perfluoroalkylene ether phosphorus acid is of the structure: 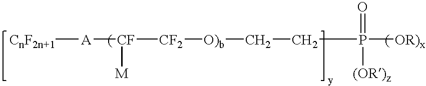
where x is 0 to 1; y is 1; z is 1 to 2; and x+y+z is 3; R is a radical having a total of 1 to 30 carbon atoms; R′ is selected from H, a metal or lower alkyl having 1 to 4 carbon atoms; A is oxygen radical or a chemical bond; n is 1 to 6; M is F or CₙF₂ₙ₊₁.

14. The method of claim 12 in which the perfluoroalkylene ether phosphorus acid is of the structure: 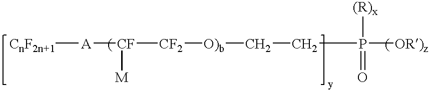
where x is 0 to 1; y is 1 to 2; z is 1; and x+y+z is 3; R is a radical having a total of 1 to 30 carbon atoms; R′ is selected from H, a metal or lower alkyl having 1 to 4 carbon atoms; A is oxygen radical or a chemical bond; n is 1 to 6; M is F or CₙF₂ₙ₊₁.

15. The method of claim 1 in which the fluorocarbon is an ester of a perfluoroalcohol.

16. The method of claim 15 in which the perfluoroalcohol is of the structure:
CₙF₂ₙ₊₁—(CF₂CF₂)_{b}—CH₂—CH₂—OH
where b is 2 to 10 and n is 1 to 6.

17. The method of claim 15 in which the ester is a triester.

18. The method of claim 17 in which the triester is of citric acid.

19. The method of claim 2 in which the fishing fly is connected to the fly fishing line and both are coated with the fluorocarbon.

20. An article selected from a fishing fly and/or a fly fishing line that are coated directly or through an intermediate primer coating with a fluorocarbon dissolved or dispersed in a liquid diluent.

21. The article of claim 20 in which the fishing fly is made of filamentous materials selected from hackle feathers and animal hair.

22. The article of claim 20 in which the fishing line comprises braided nylon filaments as a core member surrounded by a body of a plastisol.

23. The article of claim 20 in which the fluorocarbon is a perfluoro oligomer or polymer.

24. The article of claim 20 in which the fluorocarbon is a perfluorophosphorus material.

25. The article of claim 23 in which the perfluoro oligomer or polymer is a perfluorophosphorus acid.

26. The article of claim 25 in which the perfluorophosphorus acid is a phosphonic acid.

27. The article of claim 25 in which the perfluorophosphorus acid is a perfluoroalkylene ether phosphorus acid.

28. The article of claim 27 in which the perfluoroalkylene ether phosphorus acid is of the structure: 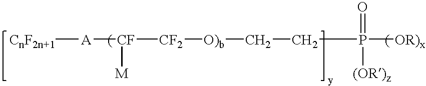
where x is 0 to 1; y is 1; z is 1 to 2; and x+y+z is 3; R is a radical having a total of 1 to 30 carbon atoms; R′ is selected from H, a metal or lower alkyl having 1 to 4 carbon atoms; A is oxygen radical or a chemical bond; n is 1 to 6; M is F or CₙF₂ₙ₊₁.

29. The article of claim 27 in which the perfluoroalkylene ether phosphorus acid is of the structure: 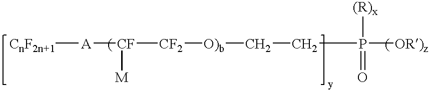
where x is 0 to 1; y is 1 to 2; z is 1; and x+y+z is 3; R is a radical having a total of 1 to 30 carbon atoms; R′ is selected from H, a metal or lower alkyl having 1 to 4 carbon atoms; A is oxygen radical or a chemical bond; n is 1 to 6; M is F or CₙF₂ₙ₊₁.

30. The article of claim 23 in which the perfluoro oligomer or polymer is an ester of a perfluoroalcohol.

31. The article of claim 30 in which the perfluoroalcohol is of the structure:
CₙF₂ₙ₊₁—(CF₂CF₂)_{b}—CH₂—CH₂—OH
where b is 2 to 10 and n is 1 to 6.

32. The article of claim 30 in which the ester is a triester.

33. The article of claim 32 in which the triester is of citric acid.

34. The article of claim 20 in which the fishing fly is connected to the fly fishing line and both are coated with the fluorocarbon.

35. The method of claim 2 in which the primer coating is derived from a transition metal oxide.

36. The article of claim 20 in which the primer coating is derived from a transition metal oxide.
